(19) United States
(12) Patent Application Publication
(10) Pub. No.: US 2021/0232461 A1
(43) Pub. Date: Jul. 29, 2021

(54) GLOBAL BACKUP SCHEDULER BASED ON INTEGER PROGRAMMING AND MACHINE LEARNING

(71) Applicant: EMC IP Holding Company LLC, Hopkinton, MA (US)

(72) Inventors: Tiago Salviano Calmon, Rio de Janeiro (BR); Hugo de Oliveira Barbalho, Rio de Janeiro (BR); Eduardo Vera Sousa, Niteroi (BR)

(21) Appl. No.: 16/773,631

(22) Filed: Jan. 27, 2020

(51) Int. Cl. G06F 11/14; G06F 11/30; G06N 20/00

(52) U.S. Cl. CPC G06F 11/1461; G06F 11/1464; G06N 20/00; G06F 11/1451; G06F 11/3034; G06F 11/1469

(57) ABSTRACT

One example method includes identifying an asset, and a backup time associated with a saveset corresponding to that asset, determining a frequency for the asset, identifying one or more available backup servers, determining a respective number of simultaneous backup streams supportable by each available backup server, and generating, or modifying, a backup schedule based on the backup time, frequency, and number of supportable backup streams. Finally, the saveset may be backed up at a time, and to a destination, specified in the backup schedule.

### FIELD OF THE INVENTION

Embodiments of the present invention generally relate to data protection. More particularly, at least some embodiments of the invention relate to systems, hardware, software, computer-readable media, and methods for data backup scheduling in a data protection environment.

### BACKGROUND

With the proliferation of data, and data generating assets such as systems, applications, and devices, and the fact that such assets may be geographically dispersed, the backup of important data has become increasingly complex. In an environment with such numerous and diverse assets, and/or where the type and/or mix of assets employed is changing over time, it is not practical to employ human scheduling of backups. It is particularly difficult, if not impossible, to devise and implement a global plan for backup scheduling. Among other things, an attempt to devise and implement such a plan would likely produce undesirable effects such as siloed information, and inefficiencies of in terms of backup appliance utilization.

As well, problems associated with the complexity of data backup scheduling also include the problem of setting feasible backup scheduling because of what is often a myopic, asset-oriented approach to scheduling. Current practices do not enforce feasibility of the scheduled plan, which is an important element in optimization. Even if feasibility is enforced, optimality of the backup plan is not considered.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses a comparison of running backup streams with waiting backup streams.

FIG. 2 discloses aspects of an example arrangement of assets and backup servers.

FIG. 3 discloses aspects of an example backup problem.

FIG. 4 discloses aspects of an example backup solution to the backup problem of FIG. 3.

FIG. 5 discloses aspects of another example backup solution.

FIG. 6 discloses aspects of an example method for generating a backup schedule.

FIG. 7 discloses aspects of an example server or other node or host.

### DETAILED DESCRIPTION OF SOME EXAMPLE EMBODIMENTS

Embodiments of the present invention generally relate to data protection. More particularly, at least some embodiments of the invention relate to systems, hardware, software, computer-readable media, and methods for data backup scheduling in an environment such as a data protection environment.

In general, example embodiments of the invention may employ an Integer Programming (IP) approach to backup scheduling. As used herein, Integer Programming embraces programs and algorithms, such as mathematical optimization or feasibility programs for example, in which one or more of the variables of the program or algorithm are required to be integers. Integer programming also embraces linear programming and/or linear programs in which both the objective function and associated parameters are linear in nature. It is noted however, that the scope of the invention is not limited to Integer programming, or to linear programs/programming.

In some embodiments at least, the IP approach may involve the use of inputs generated by a machine learning process to automatically generate and implement a backup schedule for various backup environments, one example of which may involve the backup of multiple assets into multiple backup servers. This approach may be scalable, to hundreds of assets in some embodiments, such as by using a commercial off-the-shelf (COTS) optimization solver for example, and this approach may also allow incremental updates from legacy environments.

In one example method according to an embodiment of the invention, the inputs of the backup problem to be solved are defined, and a responsive backup approach defined that addresses the requirements that are explicit, and/or implicit, in the inputs. In some embodiments, the backup approach may comprise, or consist of, a mathematical formulation. As well, in some embodiments, a machine learning (ML) model may be devised and employed that is operable to predict a backup time for each asset. Note that as used herein, an ‘asset’ refers to any application, device, system, or any combination of these, that operates to generate, and/or direct the generation of, data that may be backed up.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that an embodiment may, possibly automatically, generate and implement, a global, and service level agreement (SLA) compliant, backup schedule. In this way, a comprehensive, and adaptable, backup plan may be generated that may be effectively employed in dynamic computing environments that may include multiple assets, and whose configuration and parameters change over time. It will be apparent to the skilled person that development, implementation, and modification, of a backup plan as disclosed herein is beyond the capabilities of a human to perform, whether as a mental process and/or otherwise. As another example, an embodiment of the invention may generate a backup schedule, which may be global in scope, that may be used enterprise-wide to manage and optimally select, at least (i) where to backup data, and (ii) when to run backups of such data. In this way, efficient use of backup capabilities is employed in a way that best suits the needs and parameters of the operating environment. An embodiment may model, on a single formulation, some or all of the negotiable and non-negotiable parameters relating to a backup process. An embodiment may employ one or more machine learning tools and/or optimization tools to solve an Integer Program in order to define a backup schedule. In this way, a backup plan may be automatically defined, and/or refined, over time to take account of one or more changes in the operating environment parameters and/or other parameters. In a further example, an embodiment of the invention may abstract some, or all, of the scheduling portions from the customer and may only require, from a customer, an acceptable RPO for each of the customer assets whose data is, or may be, targeted for backup. This example embodiment may, or may not, also require input form the customer as to the relationships between the customer assets and possible destinations, such as backup servers, of the associated backups. In this way, customer input may be used in generating a backup schedule, but the requirements imposed on the customer, in terms of the input that the customer may be asked to provide, may be relatively minimal. Further, an embodiment of the invention may minimize a number of necessary backup events, thus maximizing the number of assets that can be backed up to the same destination without violating any parameter. Finally, at least some embodiments of the invention embrace an approach to backup scheduling where the number of assets and servers in an environment is such that it is simply not practical, or even possible, to obtain a feasible solution solely through human effort. Various other advantages of some example embodiments of the invention are disclosed elsewhere herein and will be apparent to one of ordinary skill in the art.

### A. Brief Overview

A brief overview is now provided concerning various considerations and concerns that may be addressed, either in part or in whole, by one or more embodiments of the invention. As well, some background is provided with which one or more embodiments of the invention may be concerned.

In many data protection schemas, backups play a central role in enabling high resilience and availability of data and, thus, protecting companies from various disruptions caused by data loss or data unavailability. As well, regulatory compliance made mandatory by governments and other entities demands that companies store some of their data for a long period of time. Because of that, it is common practice to rely on backup solutions to protect critical data from companies. In fact, companies in the US are expected to spend more $120 billion in data protection solutions by 2023, making this market a highly competitive marketplace for players with high growth potential.

In a data protection environment, there are at least two service level metrics that may be employed, namely, the Recovery Point Objective (RPO) and Recovery Time Objective (RTO). The RPO, which can have any time value, is the maximum acceptable interval of time that may pass, such as during a disruption or other event that may affect the protected data in some way, before the quantity of data lost during that period of time exceeds a maximum allowable threshold. That is, the RPO may reflect a judgment that ‘we can achieve an acceptable recovery with data that is no older than [the RPO value].’ To illustrate, if the last available copy of data is from 7 hours ago, and the RPO is 8 hours, then an acceptable data recovery may be performed using that last available copy of data. More generally, a copy of data from any time ‘t’ that is RPO may be used as the basis for a data recovery operation. In some embodiments, the RPO may be defined by the entity that owns that data that is being protected, and the RPO may be one of the terms of a service level agreement (SLA) between a data protection entity and that entity that owns the data.

The RTO refers to a duration of time, commencing with a disaster or other event affecting data that is to be protected, within which that data must be restored in order to avoid negative consequences associated with the disaster or other event. Put another way, the RTO is the amount of time that may pass before the disaster or other event begins to negatively impact the data and/or business operations associated with that data. Thus, for example, if the RTO for a given piece of data is 1 hour, this means that a recovery event must take at most one hour to make the business run as usual again. Like the RPO, the RTO may be any amount of time.

To cope with relatively small RTOs, companies may rely on various hardware and software innovations. To deal with RPOs, one approach is to schedule backups in a periodicity that respects the given SLA. For example, backups may be scheduled per asset, with the hope that the infrastructure will be able to handle an increasingly complex backup environment as assets and backup destinations are added, removed, and/or modified.

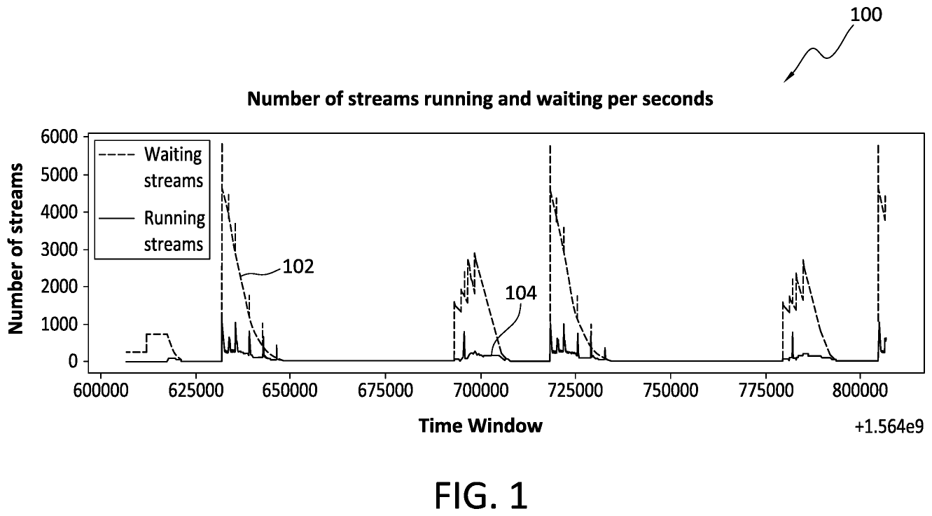

Attempting to define and implement a backup schedule in a dynamic backup environment becomes increasingly difficult as that environment grows and changes. To better illustrate, if each asset manager were to schedule backups on a per asset basis, various disruptions or other problems may occur. For instance, the maximum number of streams in a backup server might be small compared to the number of scheduled backups for the same time. This circumstance is illustrated in FIG. 1.

Particularly, FIG. 1 discloses a graph 100 comparing, for a backup environment, waiting backup streams 102 with running backup streams 104. Because backup scheduling, in the illustrative example of FIG. 1, is performed ad-hoc and on a per-asset basis, some backups might have to wait a relatively long time from their scheduled start time before they actually start. Consequently, RPO compliance may become more difficult, or even impossible.

With the foregoing points in view, embodiments of the invention embrace, among other things, automatic processes to determine a backup schedule based on service level objectives (SLO). These processes may ensure that backups occur within service levels, and, more specifically, are consistent with the RPO that has been defined for each asset. Processes within the scope of the invention may perform as few operations as possible in order to still be able to handle backups of new assets, should those backups become necessary.

In more detail, some embodiments of the invention may involve the use of an Integer Programming (IP) approach to backup scheduling. This approach considers the multiple parameters in a backup environment, both physical and negotiable (from service levels). As disclosed elsewhere herein, the parameters may function as constraints on the extent to which certain operations may be performed, if at all. The inputs to the backup scheduling process may comprise information concerning the assets and their SLAs, and an output of the scheduling process may comprise a backup schedule for one or more periods of time. Thus, embodiments of the invention may provide, for example, a simplification of the backup performance pipeline, coupled with optimality guarantees for the backup environment.

### B. Aspects of an Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, the backup, and associated, operations disclosed herein. Such operations may include, but are not limited to, data read/write/delete operations, data deduplication operations, data backup operations, data restore operations, data cloning operations, data archiving operations, disaster recovery operations, and backup schedule creation/modification operations. More generally, the scope of the invention embraces, among other things, any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example public cloud storage environments in connection with which embodiments of the invention may be employed include, but are not limited to, Dell-EMC cloud environments, Microsoft Azure, Amazon AWS, and Google Cloud. More generally however, the scope of the invention is not limited to employment of any particular type or implementation of cloud storage.

In addition to the storage environment, the operating environment may also include one or more clients that are capable of collecting, modifying, and creating, data. Thus, a particular client may employ, or otherwise be associated with, one or more instances of each of one or more applications that perform such operations with respect to data. Such clients are examples of an ‘asset’ that may be involved in one or more embodiments of the invention.

Devices in the operating environment may take the form of software, physical machines, or virtual machines (VM), or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take various forms, such as a .VMDK file for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

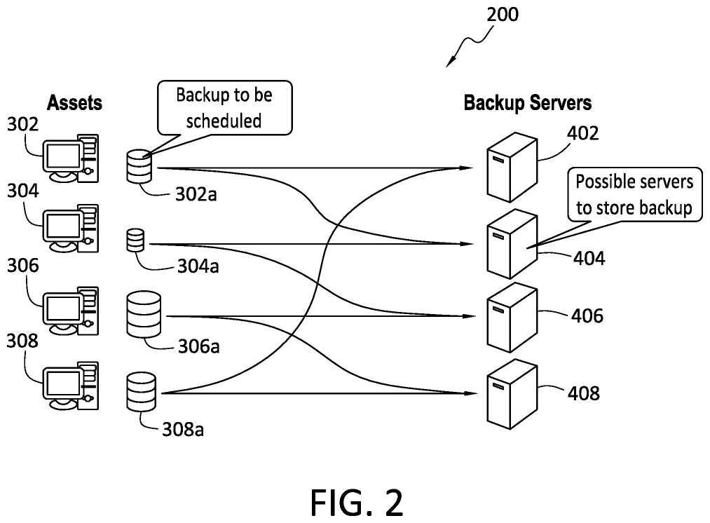

With particular attention now to FIG. 2, one example of an operating environment for embodiments of the invention is denoted generally at 200. In general, the operating environment 200 may include any number ‘n’ of assets, such as the example assets 302, 304, 306, and 308, for example. The number, and/or type, of assets in an operating environment 200 may change over time. One or more of the assets 302-308 may be associated with one or more respective savesets 302a, 304a, 306a, and 308a, that are targeted for backup. Any one or more of the savesets 302a-308a may be scheduled for backup at one or more backup servers 402, 404, 406, and/or 408. The backup server(s) 402-408 at which a particular saveset 302a-308a is to be backed up may be selected based on the configuration, capability, and/or, availability, of that backup server 402-408. In some embodiments, both a primary and secondary backup server 402-408 may be designated for one or more of the savesets 302a-308a, so that, for example, if the primary backup server 402-408 should be unavailable for some reason, the saveset 302a-308a can be backed up instead to the secondary backup server 402-408 that was designated for that saveset 302a-308a. As well, a given backup server 402-408 may be both a primary backup server 402-408 for one or more savesets 302a-308a, as well as a secondary backup server 402-408 for one or more savesets 302a-308a.

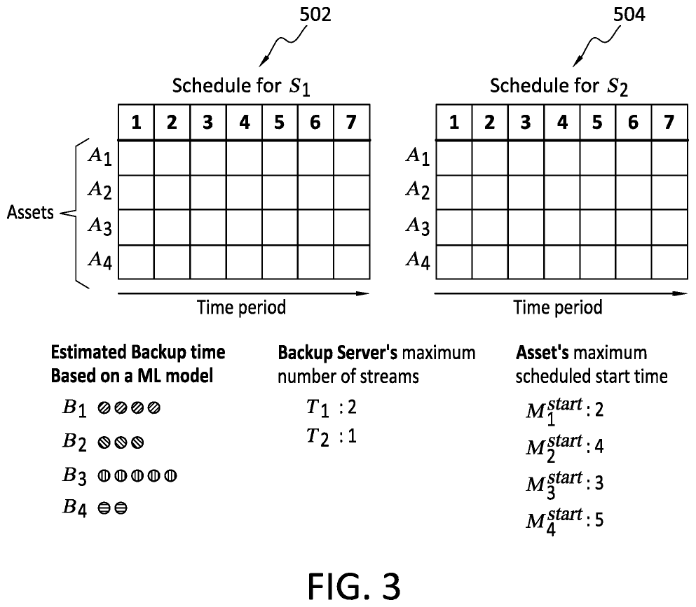

With continued reference to the example of FIG. 2, the example presented there may be considered as a pictorial representation of a backup scheduling problem to be solved. Using an associated graph (see FIG. 3, discussed below), embodiments of the invention may operate to determine where to backup one or more savesets, and when to perform the backup of those savesets.

In more detail, the assets 302-308 may be considered as making up a set A of assets, each of which implies an estimated backup time associated to its respective saveset 302a-308a to be backed up. The time estimated for backing up a saveset of an asset iϵA may be denoted by Bᵢ and may be directly derived from Machine Learning (ML), such as by way of, for example, an off-the-shelf regression technique such as Random Forest Regression. For each asset iϵA, there may also be an associated frequency Fᵢ representing the maximum amount of time the asset can wait to start its next backup. Such frequencies may be defined so as to satisfy a respective associated RPO of the savesets. Additionally, there may be a set S of Backup Servers, such as the backup servers 402-408 for example, and associated with each backup server jϵS, there may a maximum number of streams accepted by that backup server for the same period of time Tⱼ.

The whole backup is planned for a fixed window of time W={1, 2, . . . , τ} and, as such, one more piece of information may be necessary, namely, the maximum time slot to start the first backup of that optimization window, which is represented, for asset i, by Mᵢ^{start}. As well, the Backup Plan problem (BPP) may be described as follows: for each asset (A), BPP may assign and schedule the backup of the saveset for that asset to a backup server (S) to run in a specific set of continuous periods of time, that is, determine in which timeslots the respective saveset of each asset will back up to each server.

### C. Aspects of an Example Solution Space

Turning now to FIG. 3, an instance of the possible solution space, or backup problem, if the mechanism is set to operate with a time window frame W={1, 2, 3, 4, 5, 6, 7} of 7 periods is disclosed. In general, a goal is to determine at (i) which times, (ii) which assets will be performing backups to (iii) which servers. It is noted that, in some embodiments at least, once an asset is set to back up to a particular backup server, future backups of the asset may be prevented from being sent to a different backup server, unless the primary backup server is unavailable. In this way, a deduplication ratio of the backed up data may be maximized, since deduplication may be performed on a per-backup server basis. Part, or all, of a solution space may comprise, or consist of, any one or more of the parameters disclosed in FIG. 3. Any one or more of such parameters may be specified as part of an SLA, for example.

In the particular example of FIG. 3, the illustrated problem includes τ=7 different time periods, which may run consecutively, and assets A₁, A₂, A₃, and A₄. Each asset A₁ . . . A₄ has an associated estimated backup time B, where: B₁=4, B₂=3, B₃=5 and B₄=2. As well, respective first and second schedules 502 and 504 are indicated for backup server S₁ and backup server S₂. The maximum, or latest possible, scheduled start time ‘M’ for a given backup may be based upon the estimated time to perform that backup, and based on the number of different time periods τ that are available. Thus, a first backup with a relatively short time to perform may, but need not necessarily, be started later in time than a second backup whose time to perform is longer than the time to perform the first backup. Accordingly, the example of FIG. 3 indicates, for assets A₁, A₂, A₃, and A₄, respective maximum scheduled start times: M₁^{start}=2; M₂^{start}=4; M₃^{start}=3; and, M₄^{start}=5. As explained below, respective values (or sets of values) the parameters disclosed in FIG. 3 may be used as inputs to a process for generating a backup schedule.

### D. Aspects of an Approach to Solving a Backup Schedule Problem

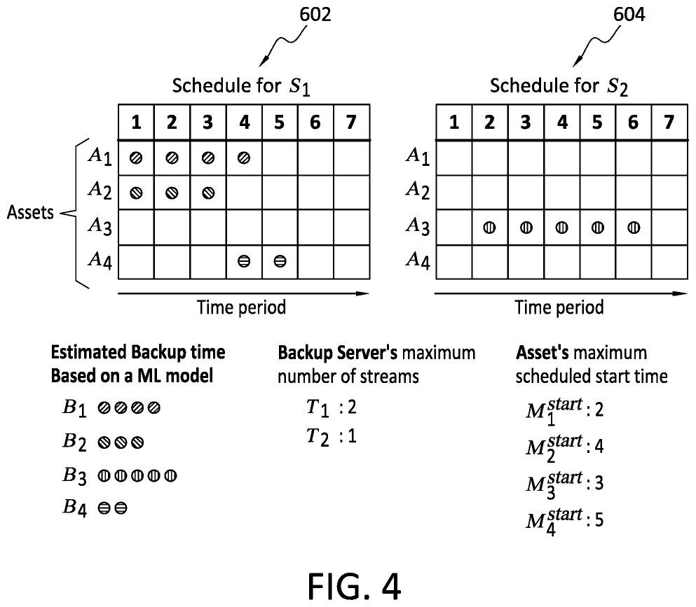

With continued reference to FIGS. 2 and 3, and directing attention now to FIG. 4 as well, an example algorithm for generating a backup schedule, such as based on the parameters discussed in connection with FIGS. 2 and 3, is presented. It is noted that (i) the algorithms disclosed herein, (ii) any and all of the equations disclosed herein, and (iii) backup schedule problems including those examples disclosed herein, may all be examples of Integer Programs. In general, the algorithm may be built upon two binary variables:
s_{i,j}^{p}: Assumes value 1 if the backup of the asset i starts at period p to a server j and 0 otherwise.
r_{i,j}^{p}: Assumes value 1 if the backup of the asset i is running at period p to a server j and 0 otherwise.

Given this, a backup schedule problem may be expressed as follows:

$$\begin{matrix}\begin{matrix}min {\sum }_{i ∈ A} {\sum }_{j ∈ S} {\sum }_{p ∈ W} {r}_{i , j}^{p} & \end{matrix} & ( 1 ) \\ \begin{matrix}s . t . {\sum }_{i ∈ A} {r}_{i , j}^{p} \leq {T}_{j} & ∀ j ∈ S , ∀ p ∈ W\end{matrix} & ( 2 ) \\ \begin{matrix}{\sum }_{j ∈ S} {\sum }_{{p ∈ W}_{p \leq {M}_{i}^{start}}} {s}_{i , j}^{p} \geq 1 & ∀ i ∈ A\end{matrix} & ( 3 ) \\ \begin{matrix}{r}_{i , j}^{p + b} \geq {s}_{i , j}^{p} & ∀ i ∈ A , ∀ j ∈ S , ∀ p ∈ W , \\ & b ∈ [ p , min ( {B}_{i} , \vert W \vert - p ]\end{matrix} & ( 4 ) \\ \begin{matrix}{\sum }_{{k ∈ S}_{k \neq j}} {\sum }_{t ∈ W} {r}_{i , k}^{t} \leq \vert W \vert ( 1 - {s}_{i , j}^{t} ) & ∀ i ∈ A , ∀ j ∈ S , ∀ p ∈ W\end{matrix} & ( 5 ) \\ \begin{matrix}{\sum }_{b = 1}^{min ( {B}_{i} , τ - t )} {s}_{i , j}^{p + b} \leq 1 - {s}_{i , j}^{p} & ∀ i ∈ A , ∀ j ∈ S , ∀ p ∈ W\end{matrix} & ( 6 ) \\ \begin{matrix}{\sum }_{b = {B}_{i}}^{{F}_{i}} {s}_{i , j}^{p + b} \geq {s}_{i , j}^{t} & ∀ i ∈ A , ∀ j ∈ S , ∀ p ∈ W\end{matrix} & ( 7 ) \\ \begin{matrix}{s}_{i , j}^{p} ∈ \{ 0 , 1 \} , {r}_{i , j}^{p} ∈ \{ 0 , 1 \} & ∀ i ∈ A , ∀ j ∈ S , ∀ p ∈ W\end{matrix} & ( 8 )\end{matrix}$$

Each of these equations and their role in the problem are now addressed. Equation 1 is the objective functional, that is, to minimize the amount of time slots in which there are backups running. This may generally be the objective since, in some embodiments at least, a goal is to perform the least amount possible of backups while respecting the parameters. This may true for several reasons including, but not limited to, the fact that it may be desirable to impact operations and network the least amount of time possible, while also keeping free as many time slots as possible in order to be able to backup new assets, if necessary.

In general, the parameters represented by equations 2-8 of the algorithm may ensure that both physical and SLA parameters are not violated. In particular, each equation may constitute a parameter that must be met in order for a backup schedule to be valid. The meaning and use of those equations are as follows: equation 2 represents the server stream parameters and may ensure that the output backup plan does not violate the maximum number of streams allowed per server at a given time slot; equation 3 may ensure that at least one backup of asset i starts until time slot Mᵢ^{start}; equation 4 is a binding parameter, and may ensure that a backup started at a time slot p runs until its completion in subsequent time slots; equation 5 is an asset-server parameter, and may ensure that after a first backup of a saveset in a backup server, all subsequent backups of the asset associated with that saveset will be performed to that same server as well—this may ensure that common backup features such as deduplication work as desired; equation 6 may ensure that a new backup does not start until an older one is being performed; equation 7 is the SLA parameter and may ensure that the RPOs of all assets are being respected; finally, equation 8 defines the domain of the decision variables and the set of valid time slots for the time window optimization problem. It is noted that that the equations 1-8 are linear in nature and, accordingly, an algorithm, such as a branch-and-bound algorithm for example, may be used to find a valid backup schedule.

As shown in FIG. 4, the output of an algorithm that includes equations 1-8 may be, for example, a full-fledged backup schedule 602 for server S1 and backup schedule 604 for server S2. In this particular case, FIG. 4 discloses a viable solution to the backup problem depicted in FIG. 3. It is noted that solution may, or may not, be the only viable solution to a particular backup problem. Further, a solution to a backup problem may, or may not, be the optimum solution to that backup problem. As well, it is noted that the ‘Estimated Backup time’ values shown in FIG. 4 may be determined, for example, using regression techniques and historical backup time data.

With continued reference to FIG. 4, it can be seen that as backup server S₁ can support a maximum of 2 simultaneous backup streams, there are never more than 2 backup streams running in any given time period. Similarly, because backup server S₂ can support a maximum of 1 backup stream, there is never more than 1 backup stream running in any given time period. It will be apparent that other solutions, while possibly less optimal than that shown in FIG. 4, may be implemented. For example, the backup stream that begins at time period 4 may be shifted to start in either of time period 5 or 6, while still completing before the time window W (comprising 7 time periods in the illustrated example) closes.

### E. Aspects of an Example ML Method

As noted herein, an important input to at least some embodiments of the invention is an estimate of the time needed to backup each of the savesets. Thus, attention is directed now to a discussion of an example of a supervised Machine Learning (ML) model to estimate such backup times.

One example ML methodology may employ features from the backup environment such as past backup speeds (s₋ₖ), current deduplication rate of past k executions d₋ₖ, and number of bytes being backed up (b). Using a regression technique, such as a Random Forest Regression (RFR) for example, and training with historical data such as may be gathered with a monitoring process and/or other processes, a model may provide a reliable performance in terms of R². Alternatively, simpler heuristics such as a statistic of previous backups may be used, which may also be an adequate proxy for the next backup. If a relatively conservative approach is desired, relatively more conservative statistics, such as 0.8 quartile instead of mean/median for instance, may be employed in the ML methodology.

In order to predict backup times, it may be helpful to distinguish new assets, whose data has not yet been backed up, from those assets whose data was previously backed up. For new backups, it may be necessary to supply information from other clients to estimate past backup speed. This information may be extracted from historical data that was collected for other assets. As well, for new backups, a dedupe ratio of 0 may be assumed, at least in some cases. In some embodiments, an initial RPO of a particular time may be assumed. Such an initial RPO may, for example, by any non-zero multiple of 24 hours, although an initial RPO may more, or less, than 24 hours.

In some embodiments, performance of one or more backup processes may be monitored, and data gathered as a result of the monitoring employed as inputs for the development of a new/modified backup schedule. Generation of a backup schedule and/or modification of an existing backup schedule may be performed by a dedicated backup scheduler module and/or server. More generally, the backup scheduling functionality disclosed herein may be employed in any suitable entity, or group of entities, and is not limited to implementation in a server. The backup scheduling functionality may be implemented in any of the environments disclosed herein, including a cloud datacenter, and/or an on-premises datacenter, for example. This entity (or entities) that embodies the backup scheduling functionality may communicate with the assets and with the backup servers to gather data concerning backup processes, and to promulgate new, and modified, backup schedules to one or more backup servers. As well, the entity that implements the backup scheduling functionality may monitor and/or survey a data protection environment to identify new assets and/or backup servers that have come online, and/or to determine when assets and/or backup servers are no longer present in the data protection environment. The results of the monitoring and/or surveying processes may be used, among other things, as inputs to the development of one or more new, or modified, backup schedules.

As will be apparent from the present disclosure, one or more embodiments of the invention may implement various useful aspects. For example, one or more embodiments may operate to generate a global backup schedule that may be used enterprise-wide to manage and optimally select where to backup data and when to run such backups. Moreover, example embodiments may model, or otherwise employ, all the negotiable and non-negotiable parameters on a single formulation and may use tools from Machine Learning and Optimization to solve an Integer Program in order to devise one or more backup schedules.

Additionally, one or more embodiments of the invention may embody an approach that may simplify backup operations and/or backup schedule generation operations, and may automate one, some, or all, of the decisions that may be needed to generate an optimized backup schedule. One embodiment of such an approach may abstract all the scheduling operations from the customer, and may only require the customer to provide (i) the acceptable RPOs for each of the customer assets whose data is to be protected, and (ii) a connectivity graph between assets and possible destinations of the backups of asset savesets. Another useful aspect of some embodiments of the invention is that they may minimize the number of required backup events, thus maximizing the number of assets that can be backed up to the same destination, while also ensuring that any relevant parameters are met.

### F. Aspects of an Experimental Validation

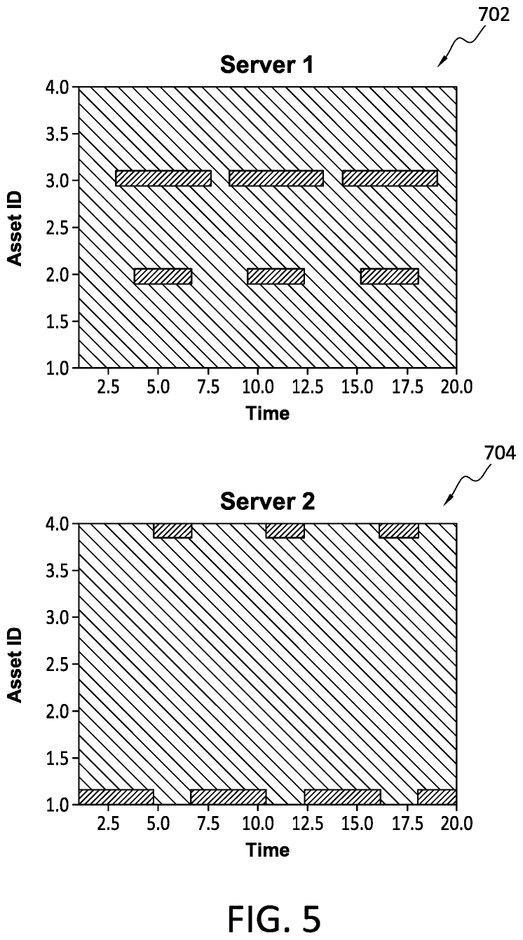

Turning next to FIG. 5, details are provided concerning one experimental validation of an embodiment of the invention. The example of FIG. 5 includes four assets and two possible destinations for the backup datasets of each of them. In this example, each timeslot is an hour long, although shorter or longer timeslots may be used. Other time slots may be used if SLAs or estimated backup times are smaller than the time unit.

Specifically, a scheduled backup plan is provided for the four assets using a 48-hour window, and given the following parameters, or parameters, of Table 1:

TABLE 1

| | |
|---|---|
| Tf (time window frame length) | 20 |

| | | | | |
|---|---|---|---|---|
| Bᵢ (estimated backup time) | 4 | 3 | 5 | 2 |

| | | |
|---|---|---|
| Tⱼ (number of supportable streams) | 2 | 1 |

| | | | | |
|---|---|---|---|---|
| Mᵢ^{start} (max scheduled start time) | 2 | 4 | 3 | 5 |
| Fᵢ (backup frequency) | 6 | 6 | 6 | 6 |

Table 1 discloses the parameters used in this example experimental validation. In Table 1, i is an index for asset, of which there are 4 in this example, and j is an index for backup servers, of which 2 are provided in the example, namely backup server 702 and backup server 704. In general, FIG. 5 discloses a solution for the backup problem set forth in Table 1. The light-colored rectangles in FIG. 5 represent a backup operation for a given asset. It can be seen in FIG. 5 that the number of concurrent streams supportable by the backup servers 702 and 704, as well as the RPO for each asset, is respected in the disclosed solution.

A number of points are evident from inspection of the solution in FIG. 5. For example, it can be seen with respect to server 2, which is only able to support 1 backup stream at a time, that at no time is there ever more than 1 backup operation being performed with respect to server 2. In this particular example, and although not required, the backup streams of assets 1 and 4 are interleaved with each other. On the other hand, as shown in FIG. 5, consistent with its ability to support up to 2 backup streams at once, server 1 has, in three different timeframes, 2 backup streams running simultaneously, namely, the respective backup streams for asset 2 and asset 3. As these examples illustrate, the backup stream parameters of the backup servers are respected by the solution of FIG. 5.

In fact, it is possible to see that all of the other parameters of Table 1 were respected as well by the solution of FIG. 5. Furthermore, it is apparent that there may be some symmetries in the solution such as, for example, the alternating pattern of backups performed at server 2, and the interleaving of backups performed at server 1. Finally, it is possible to postulate that the longer it takes for a backup solution to repeat itself can be calculated by

$${T}_{max} = {max}_{i ∈ A} \{ {M}_{i}^{start} + {F}_{i} \} .$$

### G. Example Methods

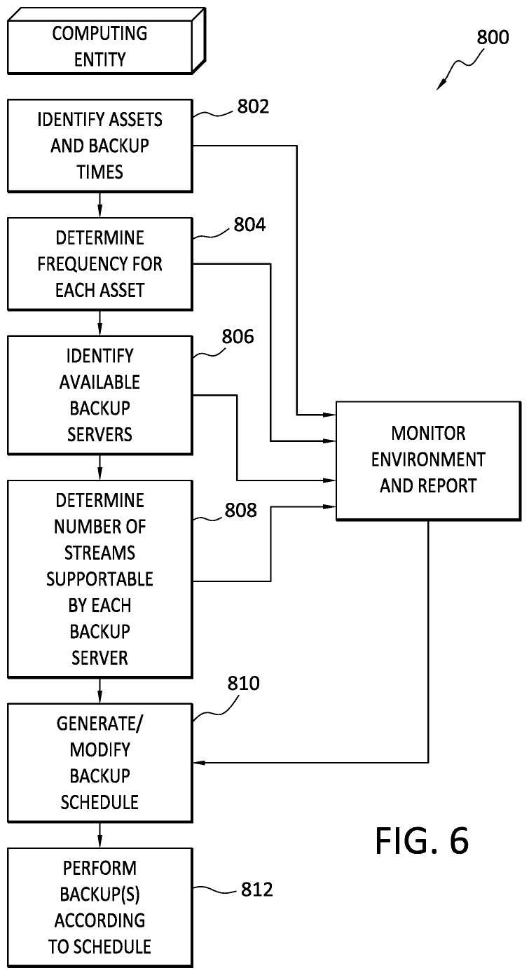

With reference now to FIG. 6, details are provided concerning methods for generating a backup schedule, where one example method is denoted generally at 800. The method 800 may be performed in its entirety by a single entity, a system, or a group of entities. In one example embodiment, the method 800 may be performed by a dedicated server, which may be located at a datacenter, such as a cloud datacenter for example. In another example embodiment, the method 800 may be performed by a backup server, either alone or in cooperation with one or more assets. In another example, part or all of the method 800 may be performed by a dedicated node that is able to communicate with the assets and backup servers. In this latter case, the backup schedule may be streamed by the dedicated node to the assets and backup servers. Thus, the allocation of functionalities disclosed in FIG. 6 is provided only by way of example, and is not intended to limit the scope of the invention in any way.

The example method 800 may begin at 802 when one or more assets and estimated, or actual, backup times associated with respective savesets of those assets are identified. The information identified at 802 may be obtained by surveying a computing environment, where such surveying may comprise, for example, communication and/or attempted communication between an interrogating computing system or computing device and one or more assets. Such communication and attempted communication may take place by way of a network or other communication system. For example, the interrogating computing system may send a ping or other electronic signal over a network in an attempt to identify assets of the network. Next, a frequency F may be identified 804 for each of the assets. As noted herein, the frequency may represent the maximum amount of time that an asset can wait to start its next backup.

With the asset information collected at 802 and 804, the method 800 may then proceed to 806 where the server, or servers, available to support the backup of asset datasets are identified. As well, the number of backup streams simultaneously supportable by each backup server may be identified 808.

It is noted that processes 802 through 808 need not be performed in the order indicated in FIG. 6. For example, in another embodiment, processes 806 and/or 808 may be performed prior to, or simultaneously with, processes 802 and/or 804.

As well, it is further noted that the information obtained at any of 802, 804, 806, and/or 808, may be pushed by the assets or backup servers, as applicable, to a dedicated server or other entity that operates to generate a new/modified backup schedule. Additionally, or alternatively, such information may be obtained by such a dedicated server and/or other entity in response to a query directed by such an entity to the assets and/or backup servers, as applicable. As well, such information may be pushed, or pulled, on a regular and/or on an ad hoc basis.

With continued reference now to FIG. 6, the information obtained at 802, 804, 806, and 808, may then be used as a basis to generate 810 a new/modified backup schedule for the identified assets and backup servers. In general, the backup schedule that is generated 810 may be consistent with various parameters, such as any of the parameters specified in an SLA. One example of such a parameter is an RPO. Thus, while a solution such as that disclosed in FIG. 4 may not explicitly refer to RPOs for the assets, it will be apparent (see, e.g., Equation 7) that the RPO forms a part of the basis for the backup schedule that is generated 810.

The backup schedule may be generated 810 using, for example, an algorithm and equations such as are disclosed herein. Further, the backup schedule 810 may be generated, in whole or in part, by any of the disclosed entities including, but not limited to, an asset, a backup server, or a dedicated server or other entity configured to execute instructions.

Finally, one or more backups may be performed 812 according to the generated schedule 810. Such backups 812 may involve one or more assets whose savesets are backed up to one or more respective backup servers.

During the time, or before or after, that part or all of the method 800 is performed, a monitoring process 814 may also be performed. In general, the monitoring process 814 may involve receiving, on a periodic, ad hoc, and/or other, basis, the data identified by the processes 802, 804, 806, and/or 808. This information may be provided by the monitoring process 814 as an input the backup schedule generation process 810. In this way, updated information about the configuration, and other aspects, of the data protection environment may be used to modify, if necessary, one or more backup schedules. Additionally, or alternatively, one or more new backup schedules 810 may be generated based on information obtained in connection with the monitoring process 814. The monitoring process 814 may, but need not, be performed by the same entity that generates the backup schedules 810.

### H. Further Example Embodiments

Following are some further example embodiments of the invention. These are presented only by way of example and are not intended to limit the scope of the invention in any way.

Embodiment 1. A method, comprising: identifying an asset, and a backup time associated with a saveset corresponding to that asset; determining a frequency for the asset; identifying one or more available backup servers; determining a respective number of simultaneous backup streams supportable by each available backup server; and generating, or modifying, a backup schedule based on the backup time, frequency, and number of supportable backup streams.

Embodiment 2. The method as recited in embodiment 1, further comprising backing up the saveset according to the backup schedule.

Embodiment 3. The method as recited in any of embodiments 1-2, further comprising monitoring a computing environment that includes the asset and the available backup servers to identify a change in the computing environment concerning the asset and/or a backup server.

Embodiment 4. The method as recited in embodiment 3, wherein data gathered as part of the monitoring process is used as a basis for generating a modified backup schedule.

Embodiment 5. The method as recited in any of embodiments 1-4, wherein the backup schedule meets an RPO requirement of the asset.

Embodiment 6. The method as recited in any of embodiments 1-5, further comprising using a machine learning process to obtain the backup time.

Embodiment 7. The method as recited in any of embodiments 1-6, wherein the backup schedule identifies a maximum scheduled start time for the asset.

Embodiment 8. The method as recited in any of embodiments 1-7, wherein the method is performed for a computing environment that comprises multiple assets and multiple backup servers.

Embodiment 9. The method as recited in any of embodiments 1-8, wherein the backup schedule indicates that the saveset of the asset is backed up to the same backup server as any previous backup of that saveset.

Embodiment 10. The method as recited in any of embodiments 1-9, wherein the backup schedule specifies: (i) where the saveset should be backed up; and, (ii) when the saveset should be backed up.

Embodiment 11. A method for performing any of the operations, methods, or processes, or any portion of any of these, disclosed herein.

Embodiment 12. A non-transitory storage medium having stored therein instructions that are executable by one or more hardware processors to perform the operations of any one or more of embodiments 1 through 11.

### I. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

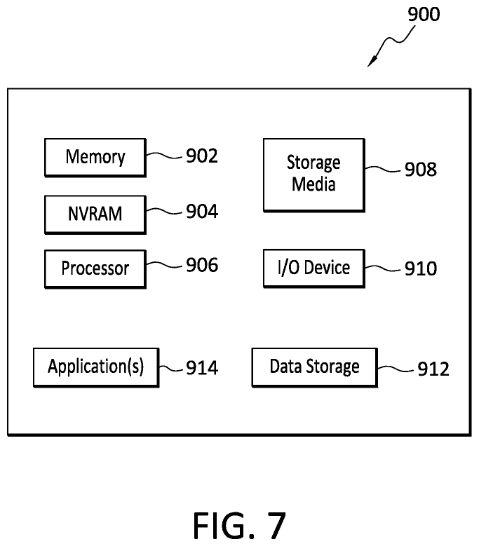

With reference briefly now to FIG. 7, any one or more of the entities disclosed, or implied, by FIGS. 1-6 and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 7.

In the example of FIG. 7, the physical computing device 900 includes a memory 902 which may include one, some, or all, of random access memory (RAM), non-volatile random access memory (NVRAM) 904, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud storage site, client, datacenter, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
identifying an asset, and a backup time associated with a saveset corresponding to that asset;
determining a frequency for the asset;
identifying one or more available backup servers;
determining a respective number of simultaneous backup streams supportable by each available backup server; and
generating, or modifying, a backup schedule based on the backup time, frequency, and number of supportable backup streams.

2. The method as recited in claim 1, further comprising backing up the saveset according to the backup schedule.

3. The method as recited in claim 1, further comprising monitoring a computing environment that includes the asset and the available backup servers to identify a change in the computing environment concerning the asset and/or a backup server.

4. The method as recited in claim 3, wherein data gathered as part of the monitoring process is used as a basis for generating a modified backup schedule.

5. The method as recited in claim 1, wherein the backup schedule meets an RPO requirement of the asset.

6. The method as recited in claim 1, further comprising using a machine learning process to obtain the backup time.

7. The method as recited in claim 1, wherein the backup schedule identifies a maximum scheduled start time for the asset.

8. The method as recited in claim 1, wherein the method is performed for a computing environment that comprises multiple assets and multiple backup servers.

9. The method as recited in claim 1, wherein the backup schedule indicates that the saveset of the asset is backed up to the same backup server as any previous backup of that saveset.

10. The method as recited in claim 1, wherein the backup schedule specifies: (i) where the saveset should be backed up; and, (ii) when the saveset should be backed up.

11. A non-transitory storage medium having stored therein instructions that are executable by one or more hardware processors to perform operations comprising:
identifying an asset, and a backup time associated with a saveset corresponding to that asset;
determining a frequency for the asset;
identifying one or more available backup servers;
determining a respective number of simultaneous backup streams supportable by each available backup server; and
generating, or modifying, a backup schedule based on the backup time, frequency, and number of supportable backup streams.

12. The non-transitory storage medium as recited in claim 11, wherein the operations further comprise backing up the saveset according to the backup schedule.

13. The non-transitory storage medium as recited in claim 11, wherein the operations further comprise monitoring a computing environment that includes the asset and the available backup servers to identify a change in the computing environment concerning the asset and/or a backup server.

14. The non-transitory storage medium as recited in claim 13, wherein data gathered as part of the monitoring process is used as a basis for generating a modified backup schedule.

15. The non-transitory storage medium as recited in claim 11, wherein the backup schedule meets an RPO requirement of the asset.

16. The non-transitory storage medium as recited in claim 11, wherein the operations further comprise using a machine learning process to obtain the backup time.

17. The non-transitory storage medium as recited in claim 11, wherein the backup schedule identifies a maximum scheduled start time for the asset.

18. The non-transitory storage medium as recited in claim 11, wherein the non-transitory storage medium is performed for a computing environment that comprises multiple assets and multiple backup servers.

19. The non-transitory storage medium as recited in claim 11, wherein the backup schedule indicates that the saveset of the asset is backed up to the same backup server as any previous backup of that saveset.

20. The non-transitory storage medium as recited in claim 11, wherein the backup schedule specifies: (i) where the saveset should be backed up; and, (ii) when the saveset should be backed up.
